(19) United States
(12) Patent Application Publication
(10) Pub. No.: US 2025/0272324 A1
(43) Pub. Date: Aug. 28, 2025

(54) ARTIFICIAL INTELLIGENCE-BASED INFORMATION RETRIEVAL APPARATUS AND METHOD FOR GENERATING ANSWER TO QUERY

(71) Applicant: Hong Kong Applied Science and Technology Research Institute Company Limited, Hong Kong (HK)

(72) Inventors: Li XU, Hong Kong (HK); Qijun ZHU, Hong Kong (HK); Likai PENG, Shenzhen (CN); Ka Hung CHONG, Hong Kong (HK); Tao YU, Hong Kong (HK)

(21) Appl. No.: 18/676,534

(22) Filed: May 29, 2024

Related U.S. Application Data
(60) Provisional application No. 63/557,590, filed on Feb. 25, 2024.

(51) Int. Cl. G06F 16/33; G06F 16/31; G06F 16/383

(52) U.S. Cl. CPC G06F 16/3344; G06F 16/322; G06F 16/3347; G06F 16/383

(57) ABSTRACT

The present invention provides an AI-based information retrieval method and system for generating an answer to a query. The method comprises: training a large language model to obtain a domain-specific large language model by obtaining one or more data structures from one or more domain-specific data respectively and creating a vector database containing context-aware data chunks generated from the one or more data structures; conducting semantic search on the vector database to obtain one or more data chunks related to the query; grouping and reordering the related data chunks based on corresponding data structures from which the related data chunks are generated to obtain one or more structure-aware contexts; performing semantic compression on the one or more structure-aware contexts based on the query to obtain a query-aware compressed prompt; and using the trained domain-specific large language model to generate the answer in response to the query-aware compressed prompt.

### CROSS-REFERENCE TO RELATED APPLICATIONS

The present application claims priority to the U.S. Provisional Patent Application No. 63/557,590 filed Feb. 25, 2024, and the disclosure of which is incorporated herein by reference in its entirety.

### FIELD OF THE INVENTION

The present invention generally relates to artificial intelligence (AI), and more specifically relates to AI-based information retrieval method and system for generating an answer to a query.

### BACKGROUND OF THE INVENTION

Businesses often need to query huge amount of information sources to get related answers for different business purposes. The current keyword-based information search platform is difficult to use as users may not know the precise terms needed for effective searches. Besides, keyword-based method cannot capture the semantic meaning embedded within documents. Consequently, lots of unrelated information are returned. Therefore, there are needs for more efficient and accurate solution for information retrieval from huge volume of documents. Recently, AI-based query-answer systems have been developed that can leverage vast amount of information and linguistic understanding encoded within natural language models in responding to user queries. Some involve dividing document paragraphs into chunks based on the description content and obtaining question-and-answer like information for each chunk. However, most existing solutions only involve sequential chunking of documents and separate chunk retrieval, without preserving original document structure and without considering the relationships between chunks, resulting in duplicated or incomprehensive information retrieval.

### SUMMARY OF THE INVENTION

It is an objective of the present disclosure to address the aforementioned shortcomings by providing a method that generates answers to queries by matching user's intent without omitting relevant information.

In accordance with a first aspect of the present invention, an AI-based information retrieval method for generating an answer to a query is provided. The method comprises training a large language model to obtain a domain-specific large language model with one or more domain-specific training data by: obtaining one or more data structures from the domain-specific data respectively; and creating a vector database containing context-aware data chunks generated from the one or more data structures. The method further comprises: conducting semantic search on the vector database to obtain one or more data chunks related to the query; grouping and reordering the related data chunks based on corresponding data structures from which the related data chunks are generated to obtain one or more structure-aware contexts; performing semantic compression on the one or more structure-aware contexts based on the query to obtain a query-aware compressed prompt; and using the trained domain-specific large language model to generate the answer in response to the query-aware compressed prompt.

In accordance with a second aspect of the present invention, an AI-based information retrieval system for generating an answer to a query is provided. The system comprises a memory configured to: store a domain-specific large language model trained with one or more domain-specific training data and one or more data structures obtained respectively from the one or more domain-specific training data; and store a vector database containing context-aware data chunks generated from the one or more data structures. The system further comprises a processor configured to: conduct semantic search on the vector database to obtain one or more data chunks related to the query; group and reorder the related data chunks based on corresponding data structures from which the related data chunks are generated to obtain one or more structure-aware contexts; perform semantic compression on the one or more structure-aware contexts based on the query to obtain a query-aware compressed prompt; and use the trained domain-specific large language model to generate the answer in response to the query-aware compressed prompt.

The current innovation is capable of generating a more coherent chunk or reference list that accurately mirrors the proximity of the results in the original documents. It can also integrate domain knowledge into the answers while avoiding the hallucination problem.

### BRIEF DESCRIPTION OF DRAWINGS

Embodiments of the invention are described in more details hereinafter with reference to the drawings, in which:

FIGS. 1A and 1B respectively show a process flowchart and a data flowchart of an AI-based information retrieval method for generating an answer to a query in accordance with one embodiment of the present invention;

FIG. 2 shows an exemplary document tree obtained in accordance with one embodiment of the present invention;

FIG. 3 shows a block diagram of an exemplary vector database created after training the domain-specific large language model according to one embodiment of the present invention;

FIG. 4 shows a flowchart of a process of generating one or more context-aware document chunks from a document tree; and

FIG. 5 shows a block diagram of an AI-based information retrieval system for generating an answer to a query in accordance with one embodiment of the present invention.

### DETAILED DESCRIPTION

In the following description, AI-based information retrieval method and system for generating answers to queries and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

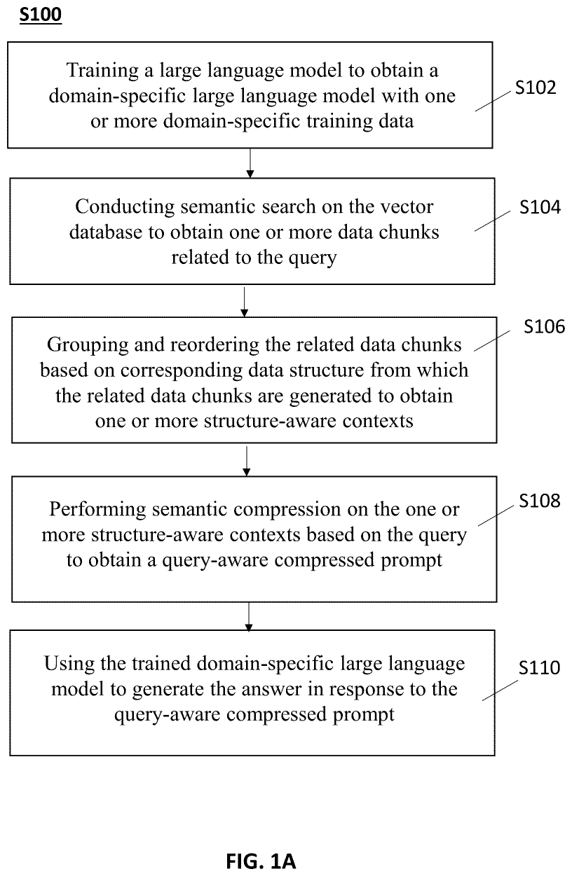

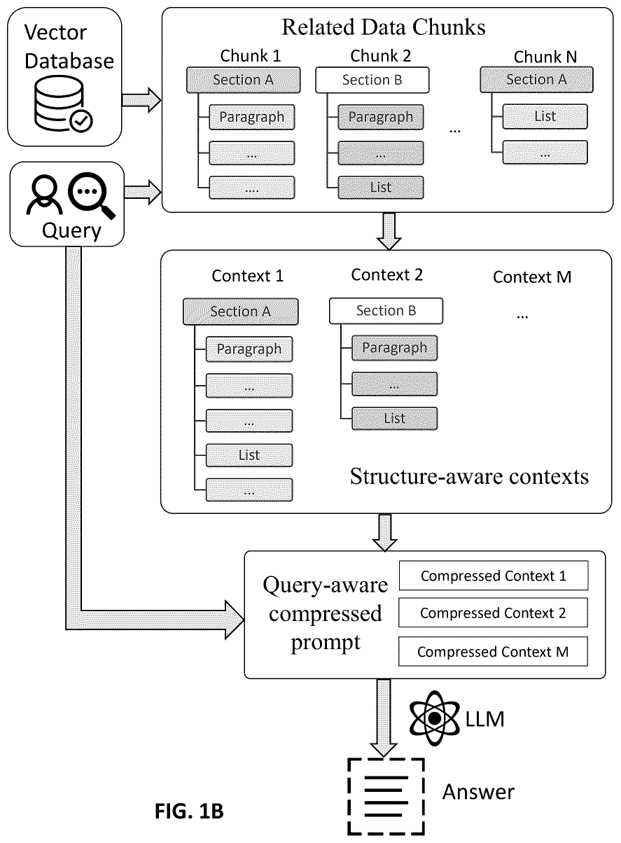

FIGS. 1A and 1B respectively show a process flowchart and data flowchart of an AI-based information retrieval method S100 for generating an answer to a query in accordance with one embodiment of the present invention. The AI-based information retrieval method comprises the following steps:

S102: training a large language model to obtain a domain-specific large language model with one or more domain-specific training data by: obtaining one or more data structures from the domain-specific data respectively; and creating a vector database containing context-aware data chunks generated from the one or more data structures;

S104: conducting semantic search on the vector database to obtain one or more data chunks related to the query;

S106: grouping and reordering the related data chunks based on corresponding data structure from which the related data chunks are generated to obtain one or more structure-aware contexts;

S108: performing semantic compression on the one or more structure-aware contexts based on the query to obtain a query-aware compressed prompt; and

S110: using the trained domain-specific large language model to generate the answer in response to the query-aware compressed prompt.

In some embodiments, the domain-specific training data are domain-specific documents. The data structures are documents trees of the domain-specific documents. The context-aware data chunks are context-aware document chunks. Each document tree is obtained by parsing a corresponding document and the document tree is expressed as a hierarchy of nodes, each node storing text contents of the corresponding document.

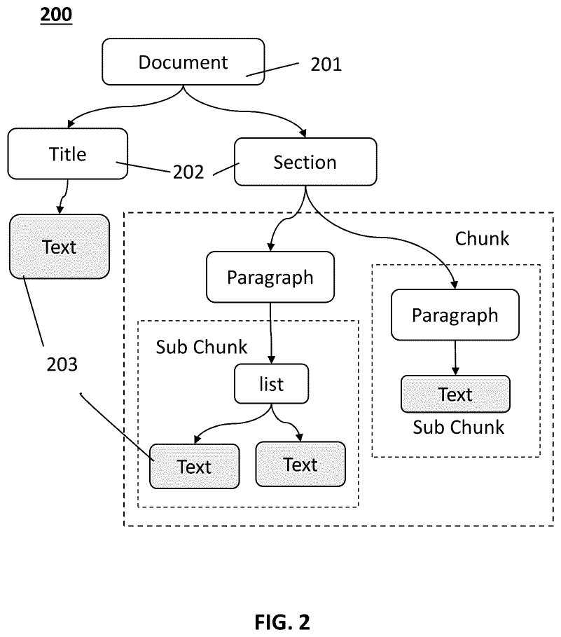

FIG. 2 shows an exemplary document tree 200 obtained in accordance with one embodiment of the present invention. As shown, the exemplary document tree comprises: a root node 201 representing (or storing) the entire document; one or more branch nodes 202 representing (or storing) the title and sections of the document respectively; and one or more leave nodes 203 representing (or storing) text contents under title and sections of the document respectively.

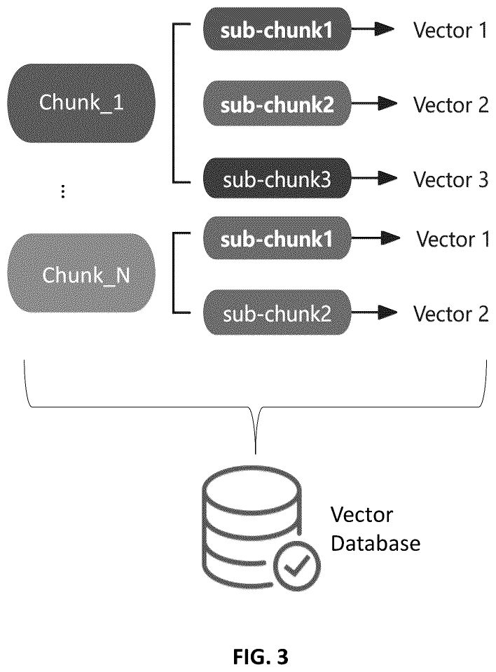

FIG. 3 shows a block diagram of an exemplary vector database created after training the domain-specific large language model according to one embodiment of the present invention. As shown, the vector database 300 includes a plurality of document chunks Chunk_1, . . . , Chunk_N, where N is the number of document chunks. Each document chunk contains a multiple of sub-chunks and is represented with an array of the sub-chunk embedding vectors.

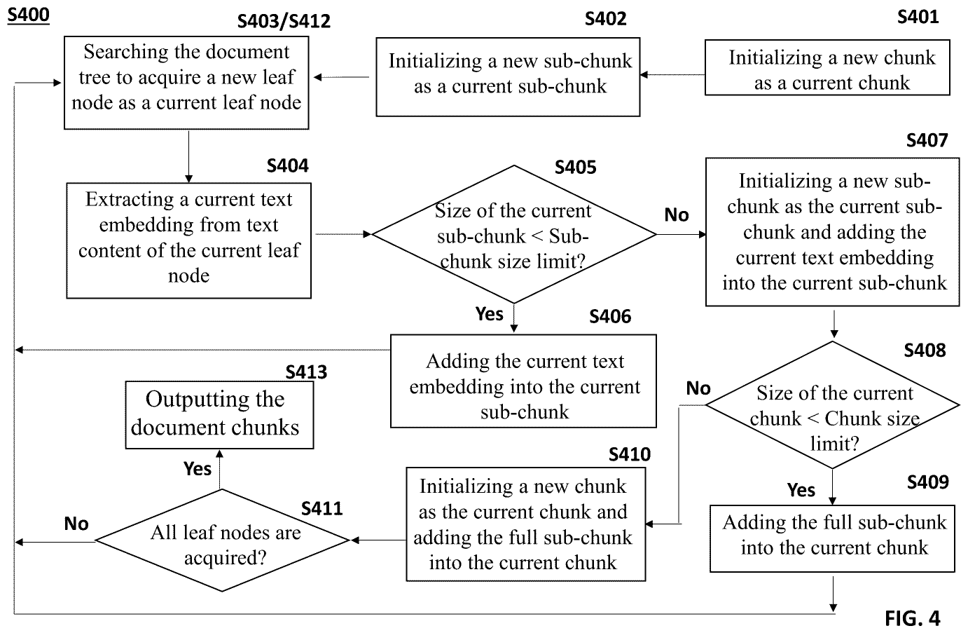

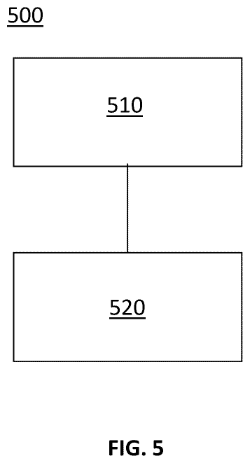

FIG. 4 shows a flowchart of a process $400 of generating one or more context-aware document chunks from a document tree in accordance with an embodiment of the present invention. The process S400 comprises the following steps:

S401: initializing a new chunk as a current chunk;

S402: initializing a new sub-chunk as a current sub-chunk;

S403: searching the document tree to acquire a new leaf node as a current leaf node;

S404: extracting a current text embedding from text content of the current leaf node;

S405: checking whether a size of the current sub-chunk is smaller than a sub-chunk size limit;

S406: if the size of the current sub-chunk is smaller than the sub-chunk size limit, adding the current text embedding into the current sub-chunk, and repeating steps S403 to S405;

S407: if the size of the current sub-chunk is equal to or greater than the sub-chunk size limit, determining that the current sub-chunk is full, initializing a new sub-chunk as the current sub-chunk and adding the current text embedding into the current sub-chunk;

S408: checking whether a size of a current chunk is smaller than a chunk size limit;

S409: if the size of the current chunk is smaller than the chunk size limit, adding the full sub-chunk into the current chunk, and repeating the steps $403 to S408;

S410: if the size of the current chunk is equal to or greater than the chunk size limit, determining that the current chunk is full, initializing a new chunk as the current chunk and adding the full sub-chunk into the current chunk;

S411: checking whether all of the leaf nodes of the document tree are acquired;

S412: if not all leaf nodes are acquired, returning to step S403.

S413: if all of the leaf nodes are acquired, outputting the context-aware document chunks.

In some embodiments, the document tree is searched using a depth-first search algorithm. More specifically, all the leaf nodes of the document tree are searched in a recursive manner.

In some embodiments, the chunk size limit is adaptively determined on basis of a context length limit of the domain-specific large language model. The sub-chunk size limit is adaptively determined on basis of an embedding size of a text embedding layer of the large language model.

In some embodiments, the step of S104 of conducting semantic search on the vector database to obtain one or more data chunks related to the query comprises: calculating a similarity value between the query and each document chunk in the vector database; and identifying the document chunk as a related document chunk if the calculated similarity value is greater than or equal to a similarity threshold.

In some embodiments, the step of $106 of grouping and reordering the related data chunks based on corresponding data structures from which the related data chunks are generated to obtain one or more structure-aware contexts comprise: grouping and reordering the related document chunks based on corresponding document trees from which the related document chunks are generated to obtain the one or more structure-aware contexts.

FIG. S shows a block diagram of an AI-based information retrieval system 500 for generating an answer to a query in accordance with one embodiment of the present invention. The AI-based information retrieval system 500 comprises a memory 510 and a processor 520.

The memory 510 is configured to: store a domain-specific large language model trained with one or more domain-specific training data and one or more data structures obtained respectively from the one or more domain-specific training data: and store a vector database containing context-aware data chunks generated from the one or more data structures.

The processor 520 is configured to conduct semantic search on the vector database to obtain one or more data chunks related to the query; group and reorder the related data chunks based on corresponding data structures from which the related data chunks are generated to obtain one or more structure-aware contexts; perform semantic compression on the one or more structure-aware contexts based on the query to obtain a query-aware compressed prompt; use the trained domain-specific large language model to generate the answer in response to the query-aware compressed prompt.

In some embodiments, the domain-specific training data are domain-specific documents. The data structures are documents trees of the domain-specific documents. The context-aware data chunks are context-aware document chunks. The processor 520 is further configured to parse each domain-specific document to obtain a corresponding document tree and expressing the document tree as a hierarchy of nodes, each node storing text contents of the document.

The processor 520 is further configured to, from each of the document trees, generate one or more context-aware document chunks by performing the following steps:
a) initializing a new chunk as a current chunk;
b) initializing a new sub-chunk as a current sub-chunk;
c) searching the document tree to acquire a new leaf node as a current leaf node;
d) extracting a current text embedding from text content of the current leaf node;
e) checking whether a size of the current sub-chunk exceeds a sub-chunk size limit;
f) if the size of the current sub-chunk does not exceed the sub-chunk size limit, adding the current text embedding into the current sub-chunk, and repeating the steps c) to e);
g) if the size of the current sub-chunk exceeds the sub-chunk size limit, determining that the current sub-chunk is full, initializing a new sub-chunk as the current sub-chunk and adding the current text embedding into the current sub-chunk;
h) checking whether a size of a current chunk exceeds a chunk size limit;
i) if the size of the current chunk does not exceed the chunk size limit, adding the full sub-chunk into the current chunk, and repeating the steps c) to h); and
j) if the size of the current chunk exceeds the chunk size limit, determining that the current chunk is full, initializing a new chunk as the current chunk and adding the full sub-chunk into the current chunk; and
k) checking whether all of the leaf nodes of the document tree are acquired;
l) if not all leaf nodes are acquired, returning to step c); and
m) if all of the leaf nodes are acquired, outputting the context-aware document chunks.

The processor 520 is further configured to conduct semantic search on the vector database to obtain the one or more data chunks related to the query by: calculating a similarity value between the query and each document chunk in the vector database; and identifying the document chunk as a related document chunk if the calculated similarity value is greater than or equal to a similarity threshold.

The processor 520 is further configured to group and reorder the related data chunks based on corresponding data structures from which the related data chunks are generated to obtain the one or more structure-aware contexts by grouping and reordering the related document chunks based on corresponding document trees from which the related document chunks are generated to obtain the one or more structure-aware contexts.

The embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data

Various embodiments of the present invention may also be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An AI-based information retrieval method for generating an answer to a query, comprising:
training a large language model to obtain a domain-specific large language model with one or more domain-specific training data by: obtaining one or more data structures from the domain-specific data respectively; and creating a vector database containing context-aware data chunks generated from the one or more data structures;
conducting semantic search on the vector database to obtain one or more data chunks related to the query;
grouping and reordering the related data chunks based on corresponding data structures from which the related data chunks are generated to obtain one or more structure-aware contexts;
performing semantic compression on the one or more structure-aware contexts based on the query to obtain a query-aware compressed prompt; and
using the trained domain-specific large language model to generate the answer in response to the query-aware compressed prompt.

2. The AI-based information retrieval method according to claim 1, wherein
the one or more domain-specific training data are one or more domain-specific documents respectively; and
the one or more data structures are one or more documents trees of the one or more domain-specific documents respectively; and
the one or more context-aware data chunks are one or more context-aware document chunks respectively.

3. The AI-based information retrieval method according to claim 2, wherein each document tree is obtained by parsing a corresponding document and the document tree is expressed as a hierarchy of nodes, each node storing text contents of the corresponding document.

4. The AI-based information retrieval method according to claim 3, wherein the hierarchy of nodes include: a root node storing the entire document; one or more branch nodes storing the title and sections of the document respectively; and one or more leave nodes storing text contents under the title and sections of the document respectively.

5. The AI-based information retrieval method according to claim 4, wherein from each of the document trees, one or more context-aware document chunks are generated by:
a) initializing a new chunk as a current chunk;
b) initializing a new sub-chunk as a current sub-chunk;
c) searching the document tree to acquire a new leaf node as a current leaf node;
d) extracting a current text embedding from text content of the current leaf node;
e) checking whether a size of the current sub-chunk exceeds a sub-chunk size limit;
f) if the size of the current sub-chunk does not exceed the sub-chunk size limit, adding the current text embedding into the current sub-chunk, and repeating the steps c) to e);
g) if the size of the current sub-chunk exceeds the sub-chunk size limit, determining that the current sub-chunk is full, initializing a new sub-chunk as the current sub-chunk and adding the current text embedding into the current sub-chunk;
h) checking whether a size of a current chunk exceeds a chunk size limit;
i) if the size of the current chunk does not exceed the chunk size limit, adding the full sub-chunk into the current chunk, and repeating the steps c) to h);
j) if the size of the current chunk exceeds the chunk size limit, determining that the current chunk is full, initializing a new chunk as the current chunk and adding the full sub-chunk into the current chunk;
k) checking whether all of the leaf nodes of the document tree are acquired;
l) if not all leaf nodes are acquired, returning to step c); and
m) if all of the leaf nodes are acquired, outputting the context-aware document chunks.

6. The AI-based information retrieval method according to claim 5, wherein the document tree is searched using a depth-first search algorithm.

7. The AI-based information retrieval method according to claim 5, wherein the chunk size limit is adaptively determined on basis of a context length limit of the domain-specific large language model.

8. The AI-based information retrieval method according to claim 5, wherein the sub-chunk size limit is adaptively determined on basis of an embedding size of a text embedding layer of the large language model.

9. The AI-based information retrieval method according to claim 2, wherein conducting semantic search on the vector database to obtain one or more data chunks related to the query comprises:
calculating a similarity value between the query and each document chunk in the vector database; and
identifying the document chunk as a related document chunk if the calculated similarity value is greater than or equal to a similarity threshold.

10. The AI-based information retrieval method according to claim 2, wherein grouping and reordering the related data chunks based on corresponding data structures from which the related data chunks are generated to obtain one or more structure-aware contexts comprises grouping and reordering the related document chunks based on corresponding document trees from which the related document chunks are generated to obtain the one or more structure-aware contexts.

11. An AI-based information retrieval system for generating an answer to a query, comprising:
a memory configured to:
store a domain-specific large language model trained with one or more domain-specific training data and one or more data structures obtained respectively from the one or more domain-specific training data; and
store a vector database containing context-aware data chunks generated from the one or more data structures;
a processor configured to:
conduct semantic search on the vector database to obtain one or more data chunks related to the query;
group and reorder the related data chunks based on corresponding data structures from which the related data chunks are generated to obtain one or more structure-aware contexts;
perform semantic compression on the one or more structure-aware contexts based on the query to obtain a query-aware compressed prompt; and
use the trained domain-specific large language model to generate the answer in response to the query-aware compressed prompt.

12. The AI-based information retrieval system according to claim 11, wherein
the one or more domain-specific training data are one or more domain-specific documents respectively;
the one or more data structures are one or more documents trees of the one or more domain-specific documents respectively; and
the one or more context-aware data chunks are one or more context-aware document chunks respectively.

13. The AI-based information retrieval system according to claim 12, wherein the processor is further configured to parse each domain-specific document to obtain a corresponding document tree and expressing the document tree as a hierarchy of nodes, each node storing text contents of the document.

14. The AI-based information retrieval system according to claim 13, wherein the hierarchy of nodes include: a root node storing the entire document; one or more branch nodes storing the title and sections of the document respectively; and one or more leave nodes storing text contents under the title and sections of the document respectively.

15. The AI-based information retrieval system according to claim 14, wherein the processor is further configured to, from each of the document trees, generate one or more context-aware document chunks by:
a) initializing a new chunk as a current chunk;
b) initializing a new sub-chunk as a current sub-chunk;
c) searching the document tree to acquire a new leaf node as a current leaf node;
d) extracting a current text embedding from text content of the current leaf node;
e) checking whether a size of the current sub-chunk exceeds a sub-chunk size limit;
f) if the size of the current sub-chunk does not exceed the sub-chunk size limit, adding the current text embedding into the current sub-chunk, and repeating the steps c) to e);
g) if the size of the current sub-chunk exceeds the sub-chunk size limit, determining that the current sub-chunk is full, initializing a new sub-chunk as the current sub-chunk and adding the current text embedding into the current sub-chunk;
h) checking whether a size of a current chunk exceeds a chunk size limit;
i) if the size of the current chunk does not exceed the chunk size limit, adding the full sub-chunk into the current chunk, and repeating the steps c) to h); and
j) if the size of the current chunk exceeds the chunk size limit, determining that the current chunk is full, initializing a new chunk as the current chunk and adding the full sub-chunk into the current chunk; and
k) checking whether all of the leaf nodes of the document tree are acquired;
l) if not all leaf nodes are acquired, returning to step c); and
m) if all of the leaf nodes are acquired, outputting the context-aware document chunks.

16. The AI-based information retrieval system according to claim 15, wherein the document tree is searched using a depth-first search algorithm.

17. The AI-based information retrieval system according to claim 15, wherein the chunk size limit is adaptively determined on basis of a context length limit of the domain-specific large language model.

18. The AI-based information retrieval system according to claim 15, wherein the sub-chunk size limit is adaptively determined on basis of an embedding size of a text embedding layer of the large language model.

19. The AI-based information retrieval system according to claim 12, wherein the processor is further configured to conduct semantic search on the vector database to obtain the one or more data chunks related to the query by:
calculating a similarity value between the query and each document chunk in the vector database; and
identifying the document chunk as a related document chunk if the calculated similarity value is greater than or equal to a similarity threshold.

20. The AI-based information retrieval system according to claim 12, wherein the processor is further configured to group and reorder the related data chunks based on corresponding data structures from which the related data chunks are generated to obtain the one or more structure-aware contexts by grouping and reordering the related document chunks based on corresponding document trees from which the related document chunks are generated to obtain the one or more structure-aware contexts.
